(19) United States
(12) Patent Application Publication
(10) Pub. No.: US 2016/0063593 A1
(43) Pub. Date: Mar. 3, 2016

(54) MEDIA INTUITIVE ONLINE SHOPPING SYSTEM

(71) Applicant: Hao LI, Taoyuan City (TW)

(72) Inventor: Hao LI, Taoyuan City (TW)

(21) Appl. No.: 14/629,061

(22) Filed: Feb. 23, 2015

(30) Foreign Application Priority Data
Sep. 2, 2014 (TW) 103130242

(51) Int. Cl. G06Q 30/06

(52) U.S. Cl. CPC G06Q 30/0629

(57) ABSTRACT

A media intuitive online shopping system includes an electronic device and a server connected to the electronic device. When the electronic device plays a program of videos and photos, an object to be purchased is selected from an image of the program by an input device of the server. The server is caused to compare and identify a merchant from a database and to display information of the identified merchant via the electronic device. A user is allowed to enter a webpage of the merchant using the input device to select a desired object (product) to perform an online product transaction. As such, in an image of a program being watched, a desired object can be selected and purchased.

### BACKGROUND OF THE INVENTION

a) Field of the Invention

The invention relates in general to a media intuitive online shopping system, and more particularly, to a system that selects a product to be purchased from an image of a program being watched to enter a webpage of a merchant selling the product and thus performs an online product transaction.

b) Description of the Prior Art

A conventional online shopping system, as disclosed by the Taiwan Patent Application No. 098116704, “Online shopping System”, for a user to evaluate an appearance matching level between at least one physical product and an object, includes a shopping platform and a user end device that connects to the shopping platform via an Internet connection. The shopping platform includes a database for storing a product schematic diagram of the physical product sold on the shopping platform. The user end device includes a service interface for providing a virtual graphic of the object to allow the user to select a coordinating position in the virtual graphic and to incorporate the product schematic diagram to the virtual graphic at the coordinating position. When the physical product is an electrical product having an electronic identification code and is in communication link with the user end device, the user may also operate the electrical product via operating software of the electrical product.

Thus, the above conventional online shopping system allows a user to evaluate an appearance matching level between at least one physical product and an object. However, during a shopping process, only a product that is sold on the merchant's webpage can be selected and purchased, and provides no access to online shopping for objects associated with male and female leading roles (e.g., from accessories such as bags and watches to clothing such as tops, skirts and pants) in current popular programs (e.g., Korean television series). As such, when a user sees objects associated with those male and female leading roles, a user is required to additionally look-up merchants that provide such objects, making purchasing the above desired objects extremely inconvenient.

Therefore, there is a need for a solution that overcomes the above issues in the purchase of desired objects in the prior art.

### SUMMARY OF THE INVENTION

In view of the drawbacks of the prior art, based on manufacturing experiences and accumulated technologies related to shopping website of the Applicant, a novel media intuitive online shopping system is provided to eliminate the drawbacks of the prior art.

It is an objective of the present invention to provide a media intuitive online shopping system, which allows online purchase of objects associated with male and female leading roles in current popular programs.

It is another objective of the present invention to provide a media intuitive online shopping system, which allows selection of a desired object in an image of a program being watched to enter a webpage of a merchant of the object and to perform an online product transaction.

To achieve the above objects, the media intuitive online shopping system is provided. The media intuitive online shopping system includes an electronic device and a server connected to the electronic device. When the electronic device plays a program of videos and photos, an object to be purchased is selected from an image of the program by an input device of the server. The server is caused to compare and identify a merchant from a database and to display information of the identified merchant via the electronic device. A user is allowed to enter a webpage of the merchant using the input device to select a desired object (product) to perform an online product transaction. As such, in an image of a program being watched, a desired object can be selected and purchased.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a media intuitive online shopping system of the present invention; and

FIG. 2 is a flowchart of a process of a media intuitive online shopping system of the present invention.

### DETAILED DESCRIPTION OF THE PREFERRED EMBODIMENTS

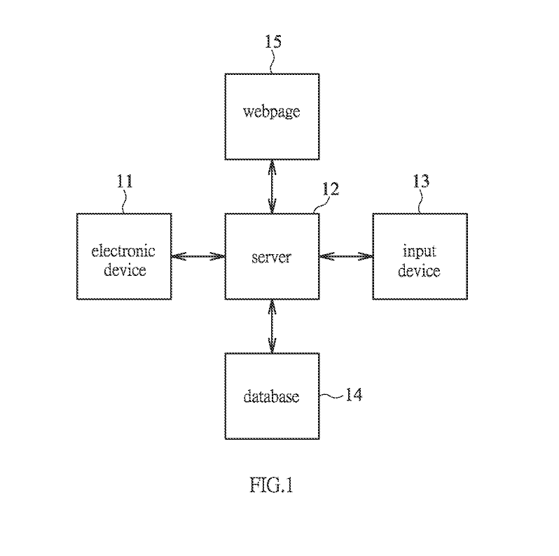

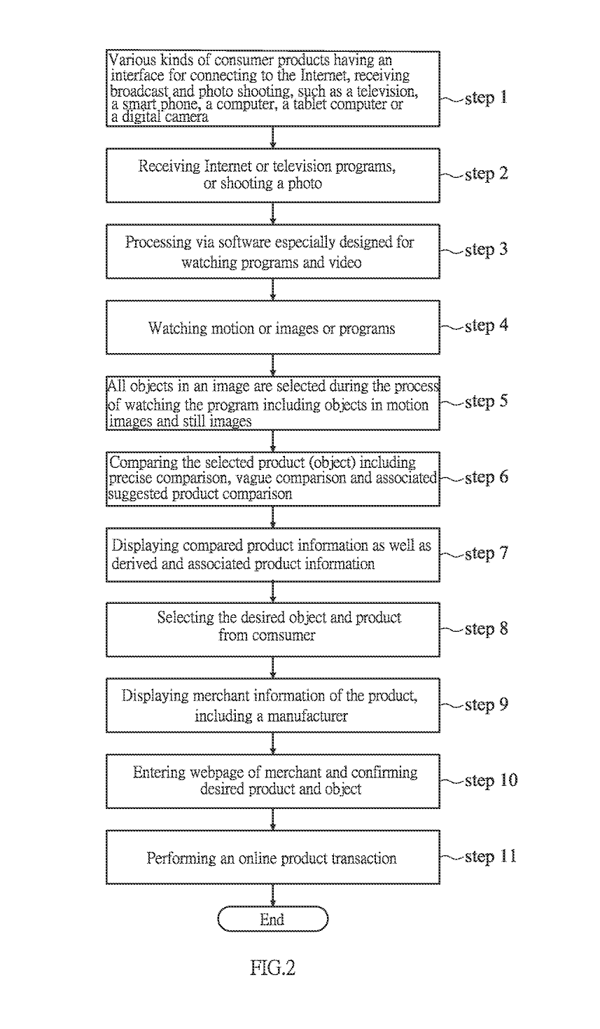

The present invention relates to a media intuitive online shopping system. Referring to FIG. 1 and FIG. 2, the media intuitive online shopping system includes an electronic device 11, and a server 12 connected to the electronic device 11. When the electronic device 11 plays a program of videos and photos, an input device 13 of the server 12 may select an object to be purchased from the image of the program. Accordingly, the server 12 is caused to compare and identify a merchant selling the object from a database 14, and to display information of the identified merchant via the electronic device 11. The user is then allowed to enter a webpage 15 of the merchant via the input device 13 to select a desired object (product) to perform an online product transaction.

As such, objects associated with male and female leading roles of popular programs can be purchased online.

Referring to FIG. 1, the electronic device 11 may be various kinds of consumer products having an interface for connecting to the Internet, receiving broadcast and photo shooting, such as a television, a smart phone, a tablet computer or a digital camera.

Referring to FIG. 1, the input device 13 may be various kinds of input devices such as a remote controller, a mouse, a keyboard, a cell phone, a joystick, a tablet computer or a smart phone.

FIG. 2 shows a flowchart of a shopping process of a media intuitive online shopping system of the present invention. The shopping process includes following steps.

In step 1, the electronic device 11 is implemented by various kinds of consumer products having an interface for connecting to the Internet, receiving broadcast and photo shooting, such as a television, a smart phone, a tablet computer or a digital camera, and is connected to the server 12.

In step 2, the electronic device 11 is utilized to receive Internet or television programs, videos, photos or still images, or to shoot a photo.

In step 3 and step 4, software in the server 12 especially designed for watching programs and videos is used to watch motion or still images or common programs.

In step 5, via the input device 13 of the server 12, all objects in an image are selected during the process of watching the program, including objects in motion images and still images.

In step 6, the server 12 compares the selected product (object) in the database 14 according to the selected product, including precise comparison, vague comparison and associated suggested product comparison.

In step 7, the server 12 displays compared product information as well as derived and associated product information via the electronic device 11.

In step 8, it is waited until the user (consumer) selects the desired object and product using the input device 13.

In step 9, the server 12 displays compared and identified merchant information via the electronic device 11. The merchant includes a manufacturer.

In step 10, a webpage 15 of the merchant is entered using the input device 13, and the desired product and object are confirmed.

In step 11, an online product transaction is performed using the input device 13, and the process ends.

As such, a desired object in any program, photo or video can be selected and purchased online.

Again referring to FIG. 2, in step 3 and step 4, the software in the server 12 for watching programs may convert all products in the videos and photos to a graphic format to promote a product search function.

Again referring to FIG. 2, in step 5, the program only needs to collaborate with a production company to perform pre-production on images regarding food, clothing, living, transportation, education and entertainment to generate production information, and to further generate a new program production sponsorship method.

Again referring to FIG. 2, in step 6, the step of comparing the relationship between the product and the merchant may achieve product exposure in the program through a media (company) to reduce the time need for actual advertisements. Thus, the entire program or photo contents may serve as an advertisement information platform. Further, a new operating mode for product launching may be established with the media (company).

Again referring to FIG. 2, in step 7, the relationship between the product in the program and the consumer is established on intuitive sales probabilities and habits. During the process of watching the media or photos, information of the contents of the images and photos can be directly obtained to determine whether a transaction to be proceeded.

Compared to the prior art, the media intuitive online shopping system of the present invention offers following advantages.

1. All objects observed in an image in different types of programs or videos can be selected, and the selected products can be purchased online.

2. In an image of a program being watched, an object to be purchased can be selected to enter a webpage of a merchant selling that object and to further perform an online production transaction.

In conclusion, the media intuitive online shopping system of the present invention is a novel structure that offers novelty and obvious improvement.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A media intuitive online shopping system, comprising:
an electronic device, and a server; wherein, the electronic device and the server is interconnected; when the electronic device plays a program of videos and photos, an object to be purchased is selected from an image of the program via an input device of the server; the server is caused to compare and identify a merchant of the object and to display information of the identified merchant via the electronic device; a user is allowed to enter a webpage of the merchant via the input device and to select a desired object (product) to perform an online product transaction.

2. The media intuitive online shopping system according to claim 1, wherein the electronic device is an interface product for connecting to the Internet, receiving broadcast and photo shooting, such as a television, a smart phone, a tablet computer or a digital camera.

3. The media intuitive online shopping system according to claim 1, wherein the input device is various kinds of input devices such as a remote controller, a mouse, a keyboard, a cell phone, a joystick, a tablet computer or a smart phone.

4. The media intuitive online shopping system according to claim 1, wherein the server includes software for watching program, videos and photo shooting, and the software converts all products in the videos and photos to a graphic format to promote a product search function.

5. The media intuitive online shopping system according to claim 1, wherein the step of comparing and identifying the merchant selling the product includes precise comparison, vague comparison and associated suggested product comparison.
